(19) United States
(12) Patent Application Publication
(10) Pub. No.: US 2020/0041160 A1
(43) Pub. Date: Feb. 6, 2020

(54) AIR CONDITIONING SYSTEM AND METHOD FOR CONTROLLING SAME

(71) Applicant: LG ELECTRONICS INC., Seoul (KR)

(72) Inventors: Hangyu KO, Seoul (KR); Dongkyu LEE, Seoul (KR)

(73) Assignee: LG ELECTRONICS INC., Seoul (KR)

(21) Appl. No.: 16/556,153

(22) Filed: Aug. 29, 2019

(30) Foreign Application Priority Data
Aug. 22, 2019 (KR) 10-2019-0102785

(51) Int. Cl. F24F 11/64; G05B 13/04; G05B 13/02

(52) U.S. Cl. CPC F24F 11/64; G05B 13/0265; G05B 13/042

(57) ABSTRACT

This method for controlling an air conditioning system teams the first learning model so as to obtain the first predicted temperature value according to the first hyper parameter updated based on the first temperature related data, learns the second control value based on the obtained first predicted temperature value, and controls an air conditioning device so as to operate the air conditioning device according to the acquired first control value.

### CROSS-REFERENCE TO RELATED APPLICATIONS

Pursuant to 35 U.S.C. § 119(a), this application claims the benefit of earlier filing date and right of priority to Korean Patent Application No. 10-2019-0102785, filed on Aug. 22, 2019, the contents of which are hereby incorporated by reference herein in its entirety.

### BACKGROUND

Embodiments relate to an air conditioning system and a method for controlling the same.

Artificial intelligence is a field of computer engineering and information technology involving studying how computers can think, learn and self-develop in ways similar to human intelligence, and means that computers can emulate intelligent actions of humans.

In addition, artificial intelligence does not exist by itself but is directly or indirectly associated with the other fields of computer science. In particular, many attempts have been made to introduce elements of artificial intelligence into various fields of information technology.

Air conditioning systems are installed in large buildings, large ships, large factories, or smart cities. Air systems should provide users with comfortable environments and be capable of efficiently consuming energy.

To this end, it is very important to optimally control the air conditioning systems. In conventional arts, air conditioning systems were controlled based on experience or intuition of operators, so that it was substantially impossible to perform optimal control.

Recently, a technique of controlling an air conditioning system based on factors such as temperatures has been proposed, but it is still difficult to achieve optimal control.

### SUMMARY

The purpose of embodiments is to solve the aforementioned limitations and other limitations.

Embodiments provide an air conditioning system capable of optimal control using artificial intelligence, and a method for controlling the same.

Embodiments also provide a method for controlling an air conditioning system including: learning a first learning model so as to acquire a first predicted temperature value according to a first hyper parameter updated based on first temperature related data; learning a second learning model so as to acquire a first control value based on the acquired first predicted temperature value; and controlling an air conditioning device so as to operate the air conditioning device according to the acquired control value.

In another embodiment, the air conditioning system includes an air conditioning device, a memory configured to store a first learning model and a second learning model; and a processor. The processor learns the first learning model so as to acquire the first predicted temperature value according to the hyper parameters updated based on the first temperature related data, learns the second control value based on the acquired first predicted temperature value, and controls the air conditioning device so as to operate the air conditioner according to the first control value.

### BRIEF DESCRIPTION OF THE DRAWINGS

FIG. 1 illustrates an AI device 100 according to an embodiment.

FIG. 2 illustrates an AI server 200 according to an embodiment.

FIG. 3 is a block diagram of an air conditioning system according to an embodiment.

FIG. 4 is a flowchart for describing a method for controlling an air conditioning system according to an embodiment.

FIG. 5 is a flowchart for describing a method for controlling an air conditioning system according to an embodiment.

FIG. 6 is a block diagram of an energy balance learning model of an air conditioning system according to an embodiment.

FIG. 7 is a flowchart for describing an operation method for an energy balance learning model of an air conditioning system according to an embodiment.

FIG. 8A illustrates a simulation result before and after applying an energy learning model, and FIG. 8B illustrates a simulation result after applying the energy learning model.

FIG. 9 is a flowchart for describing an operation method for a control learning model of an air conditioning system according to an embodiment.

FIG. 10 is a view for describing a method for setting a baseline according to an embodiment.

FIG. 11 is a view for describing a method for performing reinforcement learning with an aim of following a second line and an artificial intelligence application base line according to an embodiment.

FIG. 12 is a view for describing a method for applying mutually different compensation according to a gap position according to an embodiment.

FIG. 13 is a view for describing a comparison range of a baseline and an output value according to an embodiment.

FIG. 14 is a view for describing a method for performing reinforcement learning with an aim of setting an additional baseline and avoiding the additional baseline according to an embodiment.

FIG. 15 is a view for describing a method for discarding a parameter when an output value and one position on a second baseline coincide according to an embodiment.

FIG. 16 is a view for describing a method for re-setting a baseline according to a change in an environment condition according to an embodiment.

FIG. 17 is a bock diagram for describing an embodiment in which an artificial intelligence device is configured to be integrated with a control center according to an embodiment.

### DETAILED DESCRIPTION OF THE EMBODIMENTS

<Artificial Intelligence (AI)>

Artificial intelligence refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and may mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The artificial neural network may include an input layer, an output layer, and optionally one or more hidden layers. Each layer includes one or more neurons, and the artificial neural network may include a synapse that links neurons to neurons. In the artificial neural network, each neuron may output the function value of the activation function for input signals, weights, and deflections input through the synapse.

Model parameters refer to parameters determined through learning and include a weight value of synaptic connection and deflection of neurons. A hyper parameter means a parameter to be set in the machine learning algorithm before learning, and includes a learning rate, a repetition number, a mini batch size, and an initialization function.

The purpose of the learning of the artificial neural network may be to determine the model parameters that minimize a loss function. The loss function may be used as an index to determine optimal model parameters in the learning process of the artificial neural network.

Machine learning may be classified into supervised learning, unsupervised learning, and reinforcement learning according to a learning method.

The supervised learning may refer to a method of learning an artificial neural network in a state in which a label for learning data is given, and the label may mean the correct answer (or result value) that the artificial neural network must infer when the learning data is input to the artificial neural network. The unsupervised learning may refer to a method of learning an artificial neural network in a state in which a label for learning data is not given. The reinforcement learning may refer to a learning method in which an agent defined in a certain environment learns to select a behavior or a behavior sequence that maximizes cumulative compensation in each state.

Machine learning, which is implemented as a deep neural network (DNN) including a plurality of hidden layers among artificial neural networks, is also referred to as deep learning, and the deep running is part of machine running. In the following, machine learning is used to include mean deep running.

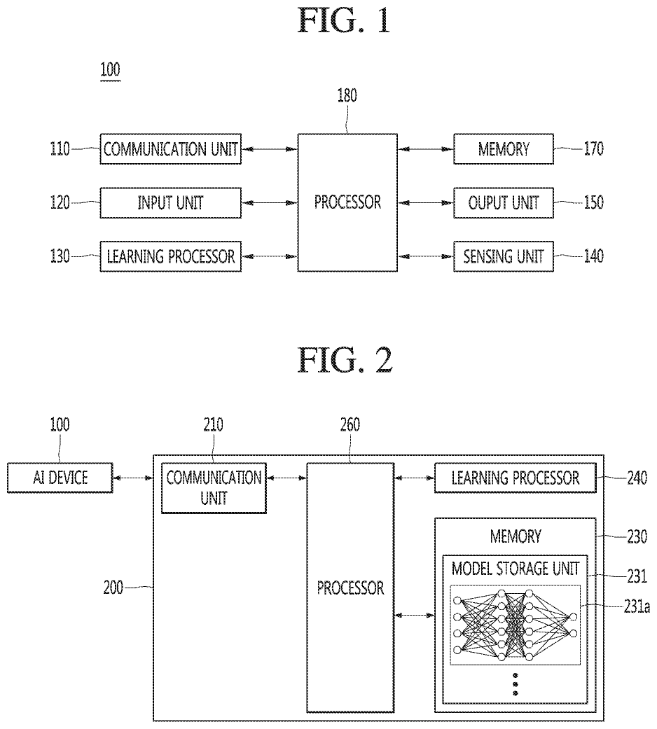

FIG. 1 illustrates an AI device 100 according to an embodiment.

The AI device 100 may be implemented by an air conditional system.

Referring to FIG. 1, the AI device 100 may include a communication unit 110, an input unit 120, a learning processor 130, a sensing unit 140, an output unit 150, a memory 170, and a processor 180.

The communication unit 110 may transmit and receive data to and from external devices such as other AI devices 100a to 100e and an AI server 200 by using wire/wireless communication technology. For example, the communication unit 110 may transmit and receive sensor information, a user input, a learning model, and a control signal to and from external devices.

The communication technology used by the communication unit 110 includes global system for mobile communication (GSM), code division multi access (CDMA), long term evolution (LTE), 5G, wireless LAN (WLAN), wireless-fidelity (Wi-Fi), Bluetooth™, radio frequency identification (RFID), infrared data association (IrDA), ZigBee, near field communication (NFC), and the like.

The input unit 120 may acquire various kinds of data.

At this time, the input unit 120 may include a camera for inputting a video signal, a microphone for receiving an audio signal, and a user input unit for receiving information from a user. Here, the camera or the microphone may be treated as a sensor, and the signal acquired from the camera or the microphone may also be referred to as sensing data or sensor information.

The input unit 120 may acquire learning data for model learning and an input data to be used when an output is acquired by using a learning model. The input unit 120 may acquire raw input data, and in this case, the processor 180 or the learning processor 130 may extract an input feature by preprocessing the input data.

The learning processor 130 may learn a model composed of an artificial neural network by using learning data. The learned artificial neural network may be referred to as a learning model. The learning model may be used to infer a result value for new input data rather than learning data, and the inferred value may be used as a basis for determination to perform a certain operation.

At this time, the learning processor 130 may perform AI processing together with the learning processor 240 of the AI server 200.

At this time, the learning processor 130 may include a memory integrated or implemented in the AI device 100. Alternatively, the learning processor 130 may be implemented by using the memory 170, an external memory directly connected to the AI device 100, or a memory held in an external device.

The sensing unit 140 may acquire at least one of internal information about the AI device 100, ambient environment information about the AI device 100, and user information by using various sensors.

Examples of the sensors included in the sensing unit 140 may include a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, a radar, or the like.

The output unit 150 may generate an output related to a visual sense, an auditory sense, a haptic sense, or the like.

At this time, the output unit 150 may include a display unit for outputting time information, a speaker for outputting auditory information, and a haptic module for outputting haptic information.

The memory 170 may store data that supports various functions of the AI device 100. For example, the memory 170 may store input data acquired by the input unit 120, learning data, a learning model, a learning history, and the like.

The processor 180 may determine at least one executable operation of the AI device 100 based on information determined or generated by using a data analysis algorithm or a machine learning algorithm. The processor 180 may control the components of the AI device 100 to execute the determined operation.

To this end, the processor 180 may request, search, receive, or utilize data of the learning processor 130 or the memory 170. The processor 180 may control the components of the AI device 100 to execute the predicted operation or the operation determined to be desirable among the at least one executable operation.

When the connection of an external device is required to perform the determined operation, the processor 180 may generate a control signal for controlling the external device and may transmit the generated control signal to the external device.

The processor 180 may acquire intention information for the user input and may determine the user's requirements based on the acquired intention information.

The processor 180 may acquire the intention information corresponding to the user input by using at least one of a speech to text (STT) engine for converting speech input into a text string or a natural language processing (NLP) engine for acquiring intention information of a natural language.

At least one of the STT engine or the NLP engine may be configured as an artificial neural network, at least a part of which is learned according to the machine learning algorithm. In addition, at least one of the STT engine or the NLP engine may be learned by the learning processor 130, may be learned by the learning processor 240 of the AI server 200, or may be learned by their distributed processing.

The processor 180 may collect history information including the operation contents of the AI device 100 or the user's feedback on the operation and may store the collected history information in the memory 170 or the learning processor 130 or transmit the collected history information to the external device such as the AI server 200. The collected history information may be used to update the learning model.

The processor 180 may control at least a part of the components of the AI device 100 so as to drive an application program stored in the memory 170. Furthermore, the processor 180 may operate two or more of the components included in the AI device 100 in combination so as to drive the application program.

FIG. 2 illustrates an AI server 200 according to an embodiment.

Referring to FIG. 2, an AI server 200 may refer to a device that learns an artificial neural network by using a machine learning algorithm or uses a learned artificial neural network. The AI server 200 may include a plurality of servers to perform distributed processing, or may be defined as a 5G network. At this time, the AI server 200 may be included as a partial configuration of the AI device 100, and may perform at least a part of the AI processing together.

The AI server 200 may include a communication unit 210, a memory 230, a learning processor 240, a processor 260, and the like.

The communication unit 210 can transmit and receive data to and from an external device such as an AI device 100.

The memory 230 may include a model storage unit 231. The model storage unit 231 may store a learning or learned model (or an artificial neural network 231a) through the learning processor 240.

The learning processor 240 may teach the artificial neural network 231a by using the learning data. The learning model may be used in a state of being mounted on the AI server 200 of the artificial neural network, or may be used in a state of being mounted on an external device such as the AI device 100.

The learning model may be implemented in hardware, software, or a combination of hardware and software. When all or parts of the learning models are implemented in software, one or more instructions that constitute the learning model may be stored in the memory 230.

The processor 260 may infer a result value for new input data by using the learning model and may generate a response or a control command based on the inferred result value.

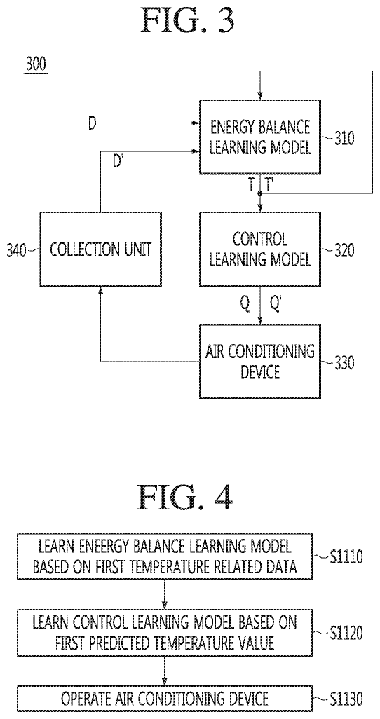

FIG. 3 is a block diagram of an air conditioning system according to an embodiment.

Referring to FIGS. 1 to 3, an air conditioning system 300 according to an embodiment may be used to be combined with an AI device 100 shown in FIGS. 1 and 2.

The air conditioning system 300 according to an embodiment may include an energy balance learning model 310 and a control learning model 320. The air conditioning system 300 according to an embodiment may include an air conditioning device 330. The air conditioning system 300 according to an embodiment may include a collection unit 340. The air conditioning system 300 according to an embodiment may include a smaller or larger number of components than the above air conditioning system.

The energy balance learning model 310 may be referred to as a first learning model, and the control learning model 320 may be referred to as a second learning model, or the models may also be conversely referred to.

The energy balance learning model 310 and the control learning model 320 may be stored in a memory 170 shown in FIG. 1. A processor 180 may learn the energy balance learning model 310 to acquire predicted temperature values T and T′. The processor 180 may learn the control learning model 320 to acquire control values Q and Q′. The processor 180 may control the collection unit 340 so as to collect temperature related data of the air conditioning device 330. The collection unit 340 may include a temperature sensor capable of acquiring the temperature related data. The collection unit 340 may be included in an input unit 120 shown FIG. 1. The collection unit 340 may include a communication module (not shown) for communication with the processor 180.

The energy balance learning model 310 may be learned so as to update hyper parameters based on the temperature related data D and D′ to acquire predicted temperature values T and T′ according to the updated hyper parameters. The temperature related data D and D′ may be temperatures or opening degrees. The opening degree may mean the opening degree of a valve. The opening degree may have a unit of percentage, but embodiments are not limited thereto. The temperature of the air conditioning device 330 may vary according to the opening degree. For example, the greater the opening degree, the lower the temperature of the air conditioning device 330 may be, but embodiments are not limited thereto. In an embodiment, the energy balance learning model 310 may receive at least one among the temperature and the opening degree.

In embodiments, the air conditioning system is controlled based on energy balance, and the energy balance may be expressed as Equation 1.

$${mC}_{p} \frac{dT}{dt} = UA ( {T}_{∞} - T ) + ɛσ A ( {T}_{∞}^{4} - {T}^{4} ) + Q \qquad [ Equation 1 ]$$

m may represent a flow rate, that is, the air amount of the air conditioning device 330, and Cp may represent a specific heat of the air. U may represent thermal conductivity, and ε may represent thermal emissivity. A may represent the area of a conductive wall surface, and T_{∞} may represent the temperature of the external air. Q may represent a control value.

The control value Q is a value acquired by the control leaning model 320, and the opening degree of the air conditioning device 330 may be adjusted according to the control value. The temperature value of the temperature related data D′ collected at the collection unit 340 may differ from the previous temperature value by the adjustment of the opening degree.

Thus, in the embodiment, the optimal predicted temperature values T and T′ are acquired at the energy balance learning model 310 by updating the hyper parameters, and the optimal control value is acquired at the control earning model by updating the control parameter based on the optimal predicted temperature values T and T′, and thus, the temperature of the air conditioning device 330 may constantly be maintained by adjusting the opening degree of the air conditioning device 330 according to the optimal control value. As such, the temperature of the air conditioning device 330 is constantly maintained, and thus, it is possible to provide users with a comfortable environment and to make efficiently energy consumption.

In Equation 1,

$${mC}_{p} \frac{dT}{dt}$$

may represent the heat introduced into a building through the air conditioning device 330, UA(T_{∞}−T−εσA(T_{∞}⁴−T⁴) may represent the heat which is generated by conduction and radiation and is to be generated at boiler/refrigerator, and which flows from the inside to the outside of the building.

In the embodiment, the hyper parameters may include at least two among a flow rate m, the specific heat Cp of the air, the area A of a conductive wall surface, or the temperature T_{∞} of the external air.

The energy balance learning model 310 may acquire the predicted temperature values T and T′ by leaning the temperature related data D. In the embodiment, the hyper parameters of the energy balance learning model 310 may be updated so as to acquire the optimal predicted temperature values T and T′. That is, the hyper parameters of the energy balance learning model 310 may be updated based on the error E of the predicted temperature values T and T′ output by the learning of the energy balance learning model 310.

The predicted temperature values T and T′ may be dependent on the hyper parameters. That is, when the hyper parameters vary, the predicted temperature values T and T′ may also vary. The energy balance learning model 310 may acquire the more accurate predicted temperature values T and T′ than the previous values by leaning the temperature related data D again according to the updated hyper parameters. The update of the hyper parameters is repeatedly performed through such a method, so that the energy balance learning model 310 may output the more accurate, that is, the optimal, predicted temperature values T and T′.

At first, the temperature related data D input to the energy balance learning model 310 may be already-provided training data. The training data may be the data firstly provided to learn the energy balance learning model 310.

In another example, the temperature related data D may be collected using the collection unit 340 by operating the air conditioning device 330 for a predetermined time period. The collected temperature related data D may be provided to the energy balance learning model 310 in order to learn the energy balance learning model 310. The predetermined time period may be a relatively short time period. For example, the predetermined time period may be comparatively short range in time. For example, the predetermined time period may be one of one hour, 10 hours, or one day.

According the embodiment, the optimal predicted temperature values T and T′ may be acquired by the update of the very small number of hyper parameters in the energy balance learning model 310, so that the computing power and a learning time may be remarkably reduced.

Meanwhile, the predicted temperature values T and T′ output by the energy balance learning model 310 may be provided to the control learning model 320. The control learning model 320 may acquire the control values Q and Q′ by learning the predicted temperature values T and T′. In addition, the control learning model 320 may update control parameters based on the predicted temperature values T and T′.

The control values Q and Q′ by may be dependent on the control parameters. That is, the control values Q and Q′ may be changed by changing the control parameters. The control learning model 320 may update the control parameters according to the predicted temperature values T and T′ . The control learning model 320 may acquire the more accurate control values Q and Q′ than the previous values by learning the predicted temperature values T and T′ again according to the updated control parameters. The update of the hyper parameters is repeatedly performed through such a method, so that the control learning model 320 may output the more accurate, that is, the optimal, control values Q and Q′ . A specific method for updating the control parameters will be described later in detail.

The processor 180 may control the air conditioning device 330 so as to operate the air conditioning device according to the acquired optimal control values Q and Q′ .

According to the embodiment, the air conditioning device 330 operates according to the control values Q and Q′ acquired more accurately and quickly based on the optimal predicted temperature values T and T′ acquired by the energy balance learning model 310, and is always maintained at a target temperature. Thus, it is possible to provide users with a comfortable environment and to efficiently make energy consumption.

FIG. 4 is a flowchart for describing a method for controlling an air conditioning system according to an embodiment.

Referring to FIGS. 1, 3 and 4, the processor 180 may perform control so as to learn an energy balance learning model 310 based on first temperature related data D (S1110). Specifically, the processor 180 may perform control the learning of the energy balance learning model 310 so as to acquire a first predicted temperature value T according to hyper parameters updated based on the first temperature related data D.

For example, the first temperature related data D may be collected by operating the air conditioning device 330 for a predetermined time period before the learning of the energy balance learning model 310. For example, the predetermined time period may include one of one hour, 10 hours, or one day.

In another example, the first temperature related data D may be already-provided training data. The energy balance learning model 310 may acquire the first predicted temperature value T corresponding to the first temperature related data D by learning the first temperature related data D. The first predicted temperature value T may be used to acquire a control value Q from a control learning model 320. That is, the control learning model 320 may acquire the control value Q by learning the first predicted temperature value T, and update control parameters in order to acquire an optimal control value Q. The update of the control parameters will be described later in detail.

The processor 180 may learn the control learning model 320 (S1120). Specifically, the processor 180 may perform control so as to learn the control learning model 320 to acquire the first control value Q based on the first predicted temperature value T.

The processor 180 may operate the air conditioning device 330 (S1130). Specifically, the processor 180 may control the air conditioning device 330 such that the air conditioning device operates according to the first control values Q. The processor 180 may adjust the opening of the air conditioning device 330 according to the first control value Q, and may operate the air conditioning device 330 at the adjusted opening degree.

According to an embodiment, the optimal predicted temperature values T and T′ may be acquired by the update of the very small number of hyper parameters in the energy balance learning model 310, so that the computing power and a learning time may be remarkably reduced.

In addition, according to an embodiment, a very small number of hyper parameters are used for the energy balance learning model, and thus, even when using relatively small amount of temperature related data, for example, temperature related data collected for one hour, 10 hours, or one day, a predicted temperature value T having sufficiently high accuracy may be acquired. Thus, computing power and the learning time may remarkably be reduced. Since the computing power may be reduced, implementation is possible even in a small-sized computer such as raspberry pi.

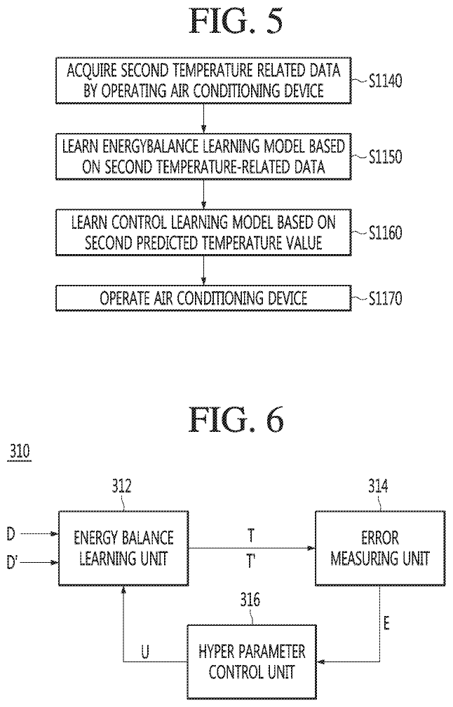

FIG. 5 is a flowchart for describing a method for controlling an air conditioning system according to an embodiment.

FIG. 5 may be subsequently operated to S1130 of FIG. 4, but embodiments are not limited thereto.

For example, according to the method for controlling the air conditioning system of FIG. 4, the energy balance learning model 310 and the control learning model 320 may be learned based on the previously collected temperature related data (first temperature related data D). Conversely, according to the method for controlling the air conditioning system of FIG. 5, the energy balance learning model 310 and the control learning model 320 may be learned based on the temperature related data (second temperature related data D′) collected from the air conditioning device 330 by the operation of the air conditioning device 330.

According to the method for controlling the air conditioning system of FIG. 5, such an operation is repeatedly performed for each period, with one period of the operation of the energy balance learning model 310, the operation of the control learning model 320, and the operation of the air conditioning model 330. Thus, optimal predicted temperature values T and T′ are acquired from the energy balance learning model 310, an optimal control value Q is acquired from the control learning model, and the temperature of the air conditioning device 330 may be maintained by controlling the air conditioning device 330 according to the optimal control value Q.

Referring to FIGS. 1, 3, 4 and 5, the processor 180 may acquire second temperature related data D′ through the collecting unit 340 by operating the air conditioning device 330 at the opening degree adjusted according to a control value Q (S1140).

The second temperature related data D′ may be collected in real time by the collection unit 340 as long as the operation of the air conditioning device 330 continues.

The processor 180 may perform control so as to learn the energy balance learning model 310 based on the second temperature related data D′ (S1150).

Specifically, the processor 180 may perform control the learning of the energy balance learning model 310 so as to acquire a second predicted temperature value T′ corresponding to the second temperature related data D′. The processor 180 may update the hyper parameters of the energy balance learning model 310 in order to optimize the second predicted temperature values T′. Compared to S1110 of FIG. 4, the learning method of S1150 is changed such that only the first temperature related data D is changed into the second temperature related data D′, and the learning method of the energy balance learning model 310 is the same as S1110 of FIG. 4.

The processor 180 may perform control so as to learn the energy balance learning model 320 based on the second temperature related data D′ (S1160).

Specifically, the processor 180 may perform control so as to learn the control learning model 320 to acquire a second control value Q based on the second predicted temperature value T′. The processor 180 may update the control parameter of the control learning model 320 to optimize a control values Q′. Compared to S1120 of FIG. 4, the learning method of S1160 is changed such that only the first control value Q is changed into a second control value Q′, and the learning method of the control learning model 320 is the same as S1120 of FIG. 4.

The processor 180 may adjust the opening of the air conditioning device 330 according to the second control value Q′, and may operate the air conditioning device 330 at the adjusted opening degree (S1170). Comparing to S1130 of FIG. 4, the operation S1170 of the air conditioning device is the same as S1130 of FIG. 4 except for controlling the air conditioning device 330 according to the second control value Q′ instead of the first control value Q.

In the aforementioned energy balance learning model 310, it was mentioned that hyper parameters were updated. Hereinafter, referring to FIG. 6, an update of the hyper parameters will be described in detail.

FIG. 6 is a block diagram of an energy balance learning model of an air conditioning system according to an embodiment.

Referring to FIGS. 1, 3 and 6, an energy balance model 310 may include an energy balance learning unit 312, an error measuring unit 314, and a hyper parameter control unit 316.

The energy balance learning unit 312 may be learned based on artificial intelligence. The energy balance learning unit 312 may acquire a predicted temperature value (first predicted temperature value) T by leaning previously collected first temperature related data D. The first temperature related data D may be training data.

The energy balance learning unit 312 may acquire a predicted temperature value (second predicted temperature value) T′ by leaning second temperature related data D′ collected in real time from the operation of an air conditioning device 330.

The error measuring unit 314 may measure the difference E between the predicted temperature values T and T′ and the actual temperature values by comparing the predicted temperature values T and T′ acquired from the energy balance learning unit 312 and the actual temperature values. The difference E may mean the error between the predicted temperature values T and T′ and the actual temperature values.

The hyper parameter control unit 316 may control the update of the hyper parameters so as to minimize the difference E between the predicted temperature values T and T′ and the actual temperature values.

In the embodiment, the hyper parameter control unit 316 may update the hyper parameters based on any one algorithm among Bayesian optimization, reinforcement learning, or Bayesian optimization & HyperBand.

For example, the hyper parameter control unit 316 may generate a hyper parameter control signal U for minimizing the difference E between the predicted temperature values T and T′ and the actual temperature values, and transmit the generated hyper parameter control signal U. The hyper parameter control unit 316 may update the hyper parameters according to the hyper parameter control signal U, and acquire the optimal predicted temperature values T and T and T′ corresponding to the temperature related data D and D′ based on the updated hyper parameters. The hyper parameter control signal U may be referred to as an update control signal.

The hyper parameters may include at least two among a flow rate m, the specific heat Cp of the air, the area A of a conductive wall surface, or the temperature T_{∞} of the external air.

The hyper parameter control unit 316 may use a combination of at least two parameters so as to minimize the difference E between the predicted temperature values T and T′ and the actual temperature values.

For example, combination A is a combination of the flow rate m and the specific heat Cp of the air, and combination B is a combination of the flow rate m and the temperature Too of the external air. At this point, assuming that a first difference E is the difference between the predicted temperature values T and T′ and the actual temperature values when the energy balance learning unit 312 is updated to the hyper parameters in combination A, and a second difference is the difference between the predicted temperature values T and T′ and the actual temperature values when the energy balance learning unit 312 is updated to the hyper parameters in combination B, and when the second difference is smaller than the first difference, the predicted temperature values T and T′ when updated to the hyper parameters in combination B may be selected as the optimal predicted temperature values and provided to the control learning model 320.

The hyper parameters control unit 316 may perform control so as to update the energy balance learning model 310 to the hyper parameters in a plurality of combinations by at least two parameters such that the difference E between the predicted temperature values T and T′ and the actual temperature values is minimized for a predetermined time. The energy balance learning model 312 may acquire the optimal predicted temperature value T and T′ corresponding to the first temperature related data D or the second temperature related data D′ on the updated hyper parameters.

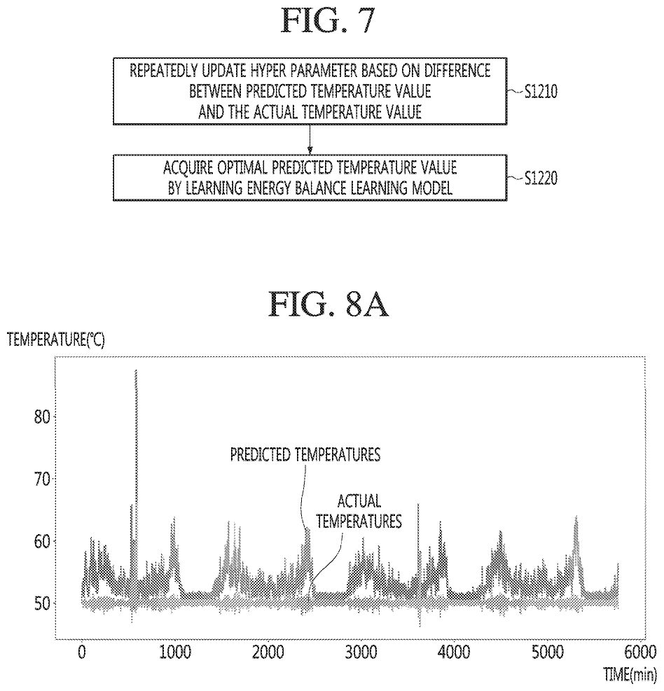

FIG. 7 is a flowchart for describing an operation method for an energy balance learning model of an air conditioning system according to an embodiment.

Referring to FIGS. 1, 3, 6 and 7, the processor 180 may repeatedly update the hyper parameters based on the difference E between the predicted temperature values T and T′ and the actual temperature values (S1210).

The processor 180 may repeatedly update the hyper parameters so that the difference E between the predicted temperature values T and T′ and the actual temperature values is minimized.

The processor 180 may acquire the optimal predicted temperature values T and T′ corresponding to the temperature related data D and D′ based on the hyper parameters by which difference E between the predicted temperature values T and T′ and the actual temperature values is minimized (S1220).

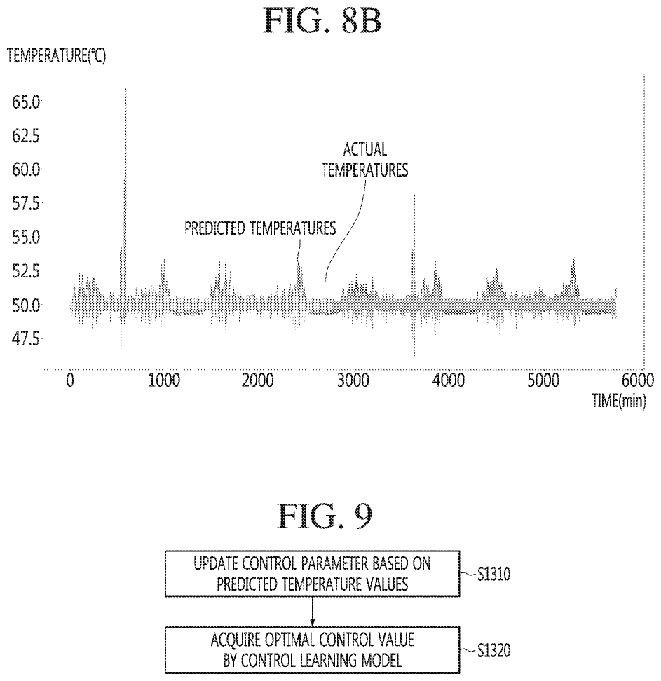

FIG. 8 illustrates a simulation result before and after applying an energy learning model. FIG. 8A illustrates a simulation result before applying an energy learning model, and FIG. 8B illustrates a simulation result after applying the energy learning model. The abscissas in FIGS. 8A and 8B represent time (min) and ordinates represent temperatures (° C.). A temperature change for approximately 5,700 minutes was simulated.

As illustrated in FIG. 8A, when an energy balance learning model is not applied, it may be found that predicted temperatures do not coincide with the actual temperatures. That is, when the energy balance learning model is not applied, it may be found that accuracy of the predicted temperature is remarkably degraded.

Conversely, as illustrated in FIG. 8B, when applying the energy balance learning model 310, it may be found that predicted temperatures almost coincide with actual temperatures. That is, when the energy balance learning model is applied, it may be found that accuracy of the predicted temperatures is remarkably improved.

From FIGS. 8A and 8B, as in the embodiment, high-accuracy and optimal predicted temperatures are acquired by using the energy balance learning model 310, and an air conditioning device 330 is operated by adjusting the opening degree according to control values Q and Q′ acquired based on the optimal predicted temperatures. Thus, a constant temperature should be maintained, comfortable environments should be provided to users, and efficient energy consumption should be possible.

FIG. 9 is a flowchart for describing an operation method for a control learning model of an air conditioning system according to an embodiment.

Referring to FIGS. 1, 3 and 9, a processor 180 may perform control so as to update a control parameter based on the predicted temperature values T and T′ acquired from an energy balance learning model 310 (S1310).

The predicted temperature values T and T′ may be the optimal predicted temperature values T and T′. As described above, the processor 180 may acquire the optimal predicted temperature values T and T′ corresponding to temperature related data D and D′ based on the hyper parameters, by which difference E between the predicted temperature values T and T′ acquired from an energy balance learning unit 312 and the actual temperature values is minimized (S1220 of FIG. 7).

The process 180 may update control parameters based on the optimal predicted temperature values T and T′. For example, the processor 180 may update the control parameters based on reinforcement learning. The reinforcement learning may refer to a learning method for an agent defined in a certain environment to select a behavior or a behavior sequence that maximizes cumulative compensation in each state.

The processor 180 may acquire optimal control values Q and Q′ by learning a control learning model based on the updated control parameters (S1320).

The processor 180 may acquire optimal control values Q and Q′ by updating the control parameters based on reinforcement learning.

The control method of the control learning model 320 will be briefly described.

Meanwhile, the control function updated in the present invention may be a control function of feedback control, which includes one or more parameters.

Terms used in the present invention will be described using the PID control function of Equation 2, for example.

$$u ( t ) = {K}_{p} e ( t ) + {K}_{i} {\int }_{0}^{t} e ( τ ) d τ + {K}_{d} \frac{de ( t )}{dt} \qquad [ Equation 2 ]$$

PID control is a control loop feedback mechanism widely used in an industrial control system.

PID control is a combination of proportional control, integral control and derivative control, which acquires a current value of an object to be controlled, compares the current value with a set point SP, calculates an error e(t) and calculates a control value CV u(t) necessary for control using the error. The control value CV may be a control value (Q in FIG. 3) obtained in the control learning model 320.

For example, in a heating system, the current value is a current temperature, the set point SP is a target temperature, and the error e(t) may be a difference between the current temperature and the target temperature.

Meanwhile, in PID control, the control value CV u(t) may be calculated by a PID control function including a proportional term Kₚe(t), an integral term and a derivative term kᵢ∫₀^{t}e(r)dr.

In this case, the proportional term Kₚe(t) is proportional to the error e(t), the integral term kᵢ∫₀^{t}e(r)dr is proportional to the integral of the error e(t), and the derivative term

$${K}_{d} \frac{de ( t )}{dt}$$

is proportional to the derivative of the error e(t).

In addition, the proportional term, the integral term and the derivative term may include a proportional gain parameter which is gain of the proportional term, an integral gain parameter Kₚ which is gain of the integral term and a derivative gain parameter K_{d} which is gain of the derivative term, respectively.

The PID parameters of the gains of the terms included in the PID function. That is, the PID parameter may include the proportional gain parameter Kₚ, the integral gain parameter Kᵢ and the derivative gain parameter K_{d}.

Output of the PID controller is the control value CV u(t), and the control value CV u(t) may be used as input of the control learning model 320. In other words, the control value CV u(t) may mean a manipulated variable MV.

In addition, the control learning model 320 may perform control corresponding to the control value CV u(t).

For example, in a heating system, when the control value CV u(t) of 80% is output by the control function, the heating system may perform control corresponding to the control value CV u(t) of 80%, that is, control for opening a valve by 80%.

Meanwhile, the output value according to control of the control learning model 320 may mean a state in which an object to be controlled by the control learning model 320 is controlled by the control learning model 320. That is, the output value may mean a process variable PV.

For example, in the heating system, the object to be controlled is a temperature and the output value may mean a temperature maintained or changed by control of the heating system.

Meanwhile, the control learning model 320 senses the output value and use the output value as the current value. In this manner, a control loop is formed and control is performed by a feedback mechanism.

Meanwhile, the artificial intelligence unit 120 may update a control function for providing a control value to the control learning model 320 based on reinforcement learning.

Reinforcement Learning is the theory that an agent can find a best way with experience thereof without data if an environment in which the agent can determine what action to take every moment is given.

Reinforcement Learning may be performed by a Markov Decision Process (MDP).

The Markov Decision Process (MDP) will be briefly described. First, an environment including information necessary for the agent to take a next action is given. Second, what action is taken by the agent in that environment is defined. Third, a reward given to the agent when the agent successfully takes a certain action and a penalty given to the agent when the agent fails to take a certain action are defined. Fourth, experience is repeated until a future reward reaches a maximum point, thereby deriving an optimal action policy.

The Markov Decision Process (MDP) is applicable to the artificial intelligence unit 120 according to the embodiment of the present invention.

Specifically, first, an environment in which the output value or the pattern of the output value is provided is given to the artificial intelligence unit 120, such that the artificial intelligence unit 120 updates the control function. Second, action of the artificial intelligence unit 120 is defined such that the output value follows the base line in order to achieve a goal. Third, a reward is given as the artificial intelligence unit follows the base line. Fourth, the artificial intelligence unit 120 repeats learning until the sum of reward is maximized, thereby deriving an optimal control function.

In this case, the artificial intelligence unit 120 may update the feedback control function based on the output value according to the control function.

Specifically, when the control learning model 320 performs control corresponding to the control value received from the control function, the artificial intelligence unit 120 may update one or more parameters of the feedback control function such that a goal is achieved through the output value according to control of the control learning model 320.

The artificial intelligence unit 120 takes an action of changing the parameter of the control function, acquires the state (output value) and the reward according to the action, and acquires a policy for maximizing the reward.

In this case, the goal achieved by the artificial intelligence unit 120 may be set by a point at which the reward is given, the magnitude of the reward, etc.

The artificial intelligence unit 120 may variously change the parameter of the control function using a try-and-error method. When the output value is acquired according to the control function having the changed parameter, the reward may be given to the acquired output value, thereby acquiring a policy for maximizing the reward.

Meanwhile, a best policy achieved by the artificial intelligence unit 120 is preset by reinforcement learning and, when the artificial intelligence unit 120 takes an action to follow the beast policy, the amount of learning of the artificial intelligence unit 120 can be significantly reduced.

Accordingly, in the present invention, it is possible to preset the best policy achieved by the artificial intelligence unit 120 by reinforcement learning.

In this case, the best policy achieved by the artificial intelligence unit 120 may mean ideal change of the output value according to control of the control learning model 320.

Here, the ideal change of the output value according to control of the control learning model 320 may be referred to as a base line.

The artificial intelligence unit 120 may update the control function for providing the control value to the control learning model 320, such that the output value according to control of the control learning model 320 follows the base line.

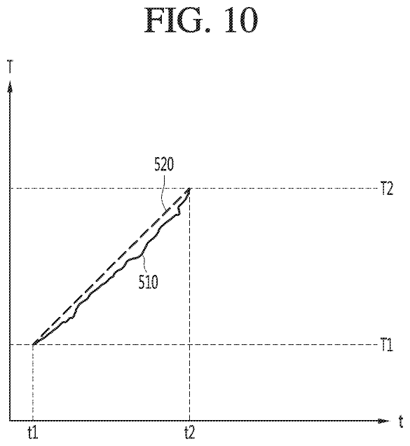

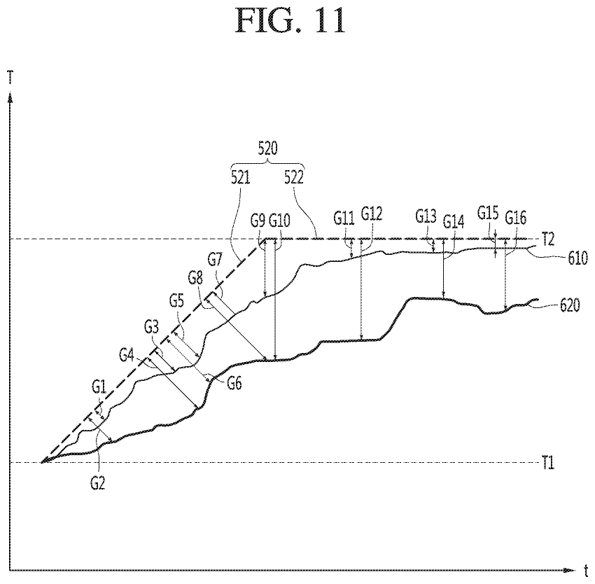

This will be described in detail with reference to FIG. 10.

FIG. 10 is a diagram illustrating a method of setting a base line according to an embodiment of the present invention.

The base line may include a first line indicating change in output value according to maximum control of the control learning model 320.

Specifically, the first line may indicate change in output value obtained when the control learning model 320 performs maximum control according to the maximum control value of the control function.

For example, in the heating system, when a maximum control value of 100% is output by the control function, the heating system may perform control corresponding to the control value of 100%, that is, control of opening the valve by 100%.

In this case, the first line may mean change in temperature, which is the object to be controlled, when the valve is opened by 100%.

Meanwhile, change 210 in output value according to maximum control of the control learning model 320 may be the first line.

The present invention is not limited thereto and the average rate 220 of change of the output value according to maximum control of the control learning model 320 may be the first line.

For example, when the heating system starts operation at a first temperature T1 at a first point of time t1 and performs maximum control to reach a second temperature T2 at a second point of time t2, the first line may indicate the average rate of change of the temperature from the first point of time t1 to the second point of time t2.

Meanwhile, the artificial intelligence unit 120 may set the first line in an environment in which the control learning model 320 is installed.

Specifically, the artificial intelligence unit 120 may control the control learning model 320 such that the control learning model 320 performs maximum control in the environment in which the control learning model 320 is installed.

For example, if the control learning model 320 is a valve system for supplying water for heating to the pipe of a specific room of a building, the artificial intelligence device 120 may control the valve system for supplying water for heating to the pipe of the specific room to maximally open the valve.

If the artificial intelligence device 100 and the control learning model 320 are separately configured, the artificial intelligence unit 120 may transmit a control command for instructing the control learning model 320 to perform maximum control to the control learning model 320.

In contrast, if the artificial intelligence device 100 and the control learning model 320 are integrally configured, the artificial intelligence unit 120 may directly control an operation unit to perform maximum control.

Meanwhile, while the control learning model 320 performs maximum control, the artificial intelligence unit 120 may acquire the output value according to maximum control of the control learning model 320. In addition, the artificial intelligence unit 120 may set the first line based on the acquired output value.

FIG. 11 is a diagram illustrating a method of performing reinforcement learning such that a second line and an artificial intelligence unit follow a base line according to an embodiment of the present invention.

The first line 221 of the base line 220 means change in output value according to maximum control of the control learning model 320 as described with reference to FIG. 10.

Here, setting the first line 221 may serve to provide artificial intelligence unit 120 with a goal of rapidly reaching a set value.

The base line 220 may further include a second line 222.

Setting the second line 222 may serve to provide the artificial intelligence unit 120 with a goal of reducing overshoot of the output value or fluctuation of the output value above or below the set value after reaching the set value.

Accordingly, the second line 222 may match the set value. Here, the set value may be a target value of the output value when specific operation is performed.

For example, when the current temperature is approximately 24° C. and a command for increasing the temperature to approximately 30° C. is received, the control learning model 320 may perform operation for increasing the temperature to approximately 30° C. In this case, the artificial intelligence unit 120 may set the base line including the first line indicating the average rate of change of the temperature when the control learning model 320 performs maximum control and the second line for increasing the temperature to approximately 30° C.

As another example, when the current temperature is approximately 24° C. and a command for increasing the temperature to approximately 27° C. is received, the control learning model 320 may perform operation for increasing the temperature to approximately 27° C. In this case, the artificial intelligence unit 120 may set the base line including the first line indicating the average rate of change of the temperature when the control learning model 320 performs maximum control and the second line for increasing the temperature to approximately 27° C.

Meanwhile, the artificial intelligence unit 120 may perform reinforcement learning such that the output value according to control of the control learning model 320 follows the base line 220.

Here, following the base line may mean that the output value according to control of the control learning model 320 most closely approaches the base line 22.

In addition, the artificial intelligence unit 120 may perform reinforcement learning such that the output value according to control of the control learning model 320 follows the base line 220, thereby acquiring one or more parameters of the control function.

Specifically, the artificial intelligence unit 120 may acquire output values 610 and 620 while variously changing the parameters of the control function in a try and error manner.

In addition, the artificial intelligence unit 120 gives a reward based on a gap between the base line 220 and the output value, thereby acquiring one or more parameters for enabling the output value according to control of the control learning model 320 to most closely follow the base line 220.

Specifically, the artificial intelligence unit 120 may calculate a gap between the base line 220 and the output at one or more points or all points.

As the gap between the base line 220 and the output value is decreased, the given reward may be increased. The artificial intelligence unit 120 may acquire one or more parameters for maximizing the reward.

For example, assume that the output value obtained when the control learning model 320 performs control according to the control value of the control function including a first parameter is a first output 610 and the output value obtained when the control learning model 320 performs control according to the control value of the control function including a second parameter is a second output 620.

Gaps G1, G3, G5, G7, G9, G11, G13 and G15 between the first output value 610 and the base line 220 are smaller than gaps G2, G4, G6, G8, G10, G12, G14 and G16 between the second output value 620 and the base line 220.

That is, the reward given when the first parameter is used is greater than the reward given when the second parameter is used. In this case, the artificial intelligence unit 120 may acquire the first parameter as the parameter for enabling the output value to most closely follow the base line.

In this manner, the artificial intelligence unit 120 may continuously perform reinforcement learning, thereby acquiring the parameter for enabling the output value according to control of the control learning model 320 to most closely follow the base line.

When a new parameter for enabling the output value according to control of the control learning model 320 to most closely follow the base line is acquired, the artificial intelligence unit 120 may change the parameter of the existing control function to the newly acquired parameter, thereby updating the existing control function.

Meanwhile, the gaps G1, G3, G5, G7, G9, G11, G13 and G15 shown in FIG. 11 indicate the distances between the output value and the base line at several points and are merely exemplary.

For example, the gap between the output value and the base line may mean the area of a space between the output value and the base line.

That is, the area of the space between the first output value 610 and the base line 220 when the first parameter is used may be smaller than that of the space between the second output value 620 and the base line 220 when the second parameter is used. In this case, a reward given when the first parameter is greater than a reward given when the second parameter is used. The artificial intelligence unit 120 may acquire the first parameter as the parameter for enabling the output value to most closely follow the base line.

That is, the gap described in this specification may mean a difference between the base line and the output value.

The output value according to control of the control learning model 320 is not determined only by control of the control learning model 320 but is determined by various variables.

For example, in the heating system, the output value according to control of the control learning model 320 is determined by various variables such as season, weather, time, date, the area of a space, whether a window is opened, the number of persons in a space, whether a door is opened, whether an insulator is used, etc.

Since it is impossible for humans to analyze various variables to calculate an optimal parameter, a PID parameter has been directly set by humans based on human experience and intuition. As a similar example, in baduk where there are a large number of cases, baduk players find moves based on experience and intuition thereof.

However, the present invention is advantageous in that a learning environment is provided to an artificial intelligence agent and the artificial intelligence agent learns a large amount of data, thereby calculating an optimal parameter regardless of various variables for determining the output value. As a similar example, in baduk where there are a large number of cases, an artificial intelligence agent learns the record of baduk to find optimal moves.

In an operating environment of the control learning model 320, in which there are various variables and a set value may be changed whenever operation is performed, how to set the goal of the artificial intelligence agent may come into question.

However, the present invention is advantageous in that a clear goal of following the base line is given to the artificial intelligence agent and the artificial intelligence agent performs learning such that the gap between the base line and the output value is minimized, thereby improving learning ability and learning speed of the artificial intelligence agent.

In addition, the first line of the base line indicates the output value according to maximum control of the control learning model 320 and the second line of the base line indicates the set value of specific operation. Accordingly, according to the present invention, a goal of rapidly reaching a set value and a goal of stabilizing a system such as reduction of overshoot or fluctuation of an output value are simultaneously given to the artificial intelligence agent.

In addition, even when the same control learning model 320 performs the same operation, the output value may be changed according to a place where the control learning model 320 is installed.

For example, even when the valve of a heating system installed Thailand having a hot climate and the valve of a heating system installed in Russia having a cold climate are equally opened by 80%, the average rate of change of the output value in Thailand and the average rate of change of the output value in Russia may be different.

As another example, the average rate of change of the output value in a first building with good insulation and the average rate of change of the output value in a second building with poor insulation may be different from each other.

However, the first line of the present invention is set based on the output value by maximum control in an environment in which the control learning model 320 is installed. That is, the first line is set according to the characteristics of the environment in which the control learning model 320 is installed and the artificial intelligence agent performs reinforcement learning in order to follow the first line. Therefore, according to the present invention, it is possible to find an optimal control function suitable for an environment in which the control learning model 320 is installed.

Meanwhile, the artificial intelligence unit according to the present invention may set at least one of one or more base lines and a reward based on a gap between the one or more base lines and an output value, according to a plurality of operation goals of a control learning model 320, and perform reinforcement learning based on the gap between the one or more base lines and the output value.

Here, the plurality of operation goals of the control learning model 320 may include at least one of a goal that an output value rapidly reaches a set value, a goal of reducing fluctuation of the output value, a goal of reducing overshoot of the output value, a goal that the output value follows and a goal that the output value avoids.

First, a method of setting a reward based on a gap between one or more base lines and an output value, according to a plurality of operation goals of a control learning model 320, and performing reinforcement learning will be described.

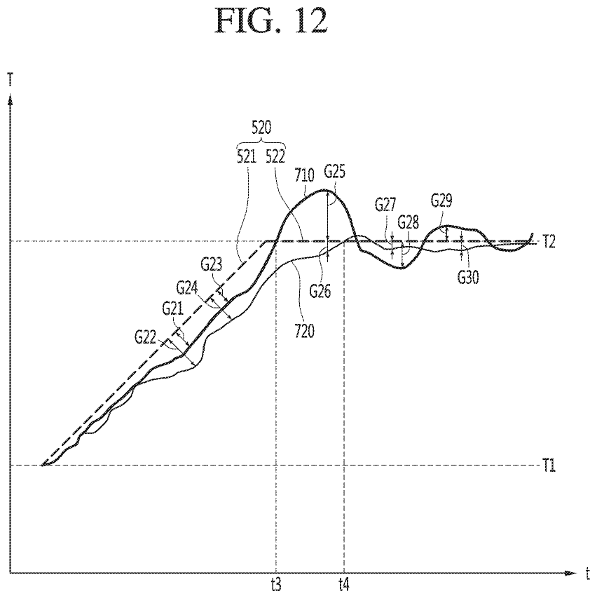

FIG. 12 is a diagram illustrating a method of giving different rewards according to the position of a gap according to an embodiment of the present invention.

The artificial intelligence unit 120 may set a reward based on a gap between one or more base lines and an output value, according to a plurality of operation goals of a control learning model 320.

For example, the artificial intelligence unit 120 may set a base line 220 according to a goal that the output value follows, set a reward based on a gap between a first line 221 and the output value, according to a goal that the output value rapidly reaches a set value, and set a reward based on a gap between a second line 222 and the output value, according to a goal of reducing overshoot and fluctuation of the output value.

In this case, the artificial intelligence unit 120 may give different rewards according to the position of the gap between the base line and the output value.

Specifically, the artificial intelligence unit 120 may give a first reward based on the gap between the first line 221 and the output value and give a second reward based on the gap between the second line 222 and the output value. In this case, the first reward and the second reward may be different from each other.

For example, assume that the output value obtained when the control learning model 320 performs control according to the control value of the control function including the first parameter is a first output value 710 and the first reward is greater than the second reward.

The gaps G21, G23, G25, G27 and G29 between the base line 220 and the first output value 710 may include gaps G21 and G23 between the first line 221 and the first output value 710 and the gaps G25, G27 and G29 between the second line 222 and the first output value 710.

Meanwhile, the first reward is given as the gaps G21 and G23 between the first line 221 and the first output value 710 are small and the second reward is given when the gaps G25, G27 and G29 between the second line 222 and the first output value 710 are small. In addition, the first reward may be greater than the second reward.

For example, when the first gap G21 between the first line 221 and the first output value 710 is 10 and the second gap G29 between the second line 222 and the first output value 710 is 10, a reward of 5 may be given to the first gap G21 and a reward of 2 may be given to the second gap G29.

Accordingly, when an optimal control function following the base line in a state in which the first reward is greater than the second reward is acquired, the output value according to the optimal control function may be closer to the first line 221 than the second line 222. That is, the gap between the output value according to the optimal control function and the first line 221 may be less than the gap between the output value according to the optimal control function and the second line 222.

For example, if it is assumed that the output value according to the optimal control function is a first output value 710 when the first reward is greater than the second reward, the first output value 710 may be closer to the first line 221 than the second line 222.

In contrast, assume that the output value obtained when the control learning model 320 performs control according to the control value of the control function including the second parameter is a second output value 720 and the first reward is less than the second reward.

The gaps G22, G24, G26, G28 and G30 between the base line 220 and the second output value 720 may include the gaps G22 and G24 between the first line 221 and the second output value 720 and the gaps G26, G28 and G30 between the second line 222 and the second output value 720.

Meanwhile, the first reward is given as the gaps G22 and G24 between the first line 221 and the second output value 720 are small and the second reward is given as the gaps G26, G28 and G30 between the second line 222 and the second output value 720 is small. In addition, the first reward may be less than the second reward.

For example, when the first gap G22 between the first line 221 and the first output value 720 is 10 and the second gap G28 between the second line 222 and the first output value 720 is 10, a reward of 2 may be given to the first gap G22 and a reward of4 may be given to the second gap G28.

Accordingly, when an optimal control function following the base line in a state in which the first reward is less than the second reward is acquired, the output value according to the optimal control function may be closer to the second line 222 than the first line 221. That is, the gap between the output value according to the optimal control function 221111n and the second line 222 may be less than the gap between the output value according to the optimal control function and the first line 221.

For example, if it is assumed that the output value according to the optimal control unction is the second output value 720 when the first reward is less than the second reward, the second output value 720 may be closer to the second line 222 than the first line 221.

As described above, setting the first line may serve to provide the artificial intelligence unit 120 with a goal of rapidly reaching the set value to and setting the second line 222 may serve to provide the artificial intelligence unit 120 with a goal of reducing overshoot of the output value or fluctuation of the output value above or below the set value after reaching the set value.

That is, in the present invention, after weighting various operational goals in a manner of giving different rewards according to the position of the gap, the artificial intelligence agent may find an optimal parameter according to the weighted operational goals.

For example, referring to the first output value 710, when a greater reward is given to the gap between the first line 221 and the output value, a point of time t3 when the output value reaches the set value may be advanced but overshoot may be increased or fluctuation of the output value above or below the set value may be increased. Accordingly, this may be advantageous in terms of rapid control to the set value but may be disadvantageous in terms of power consumption and system stabilization.

For example, referring to the second output value 720, when a greater reward is given to the gap between the second line 222 and the output value, a point of time t4 when the output value reaches the set value may be delayed and overshoot may be decreased or fluctuation of the output value above or below the set value may be decreased. Accordingly, this may be disadvantageous in terms of rapid control to the set value but may be advantageous in terms of power consumption and system stabilization.

That is, the present invention is advantageous in that the reward is changed according to the position of the gap to variously combine various operational goals according to a degree of importance and to acquire an optimal parameter.

Although different rewards are given to the gap between the first line and the output value and the gap between the second line and the output value in the above description, the present invention is not limited thereto and the magnitude of the reward may be variously changed according to the operational goal.

For example, when desiring to give a high weight to an operational goal of minimizing overshoot, a greater reward may be given to the gap G25 at the position where overshoot occurs with the base line 220 than the other gaps G27 and G29.

As another example, when desiring to give a high weight to a goal of reducing fluctuation of the output value above or below the set value to rapidly stabilize the system, a greater reward may be given to the gaps G27 and G29 at the position where the output value fluctuates above or below than the set value than the gap G25.

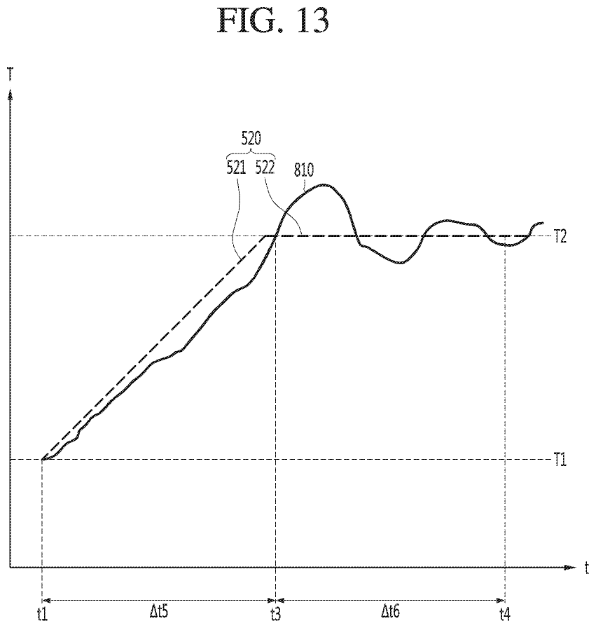

FIG. 13 is a diagram illustrating a comparison range between a base line and an output line according to an embodiment of the present invention.

The artificial intelligence unit 120 may perform reinforcement learning such that the output value 810 according to control of the control learning model 320 follows the base line 220.

In this case, the artificial intelligence unit 120 may perform reinforcement learning such that an output value 810 follows a first line 221 until the output value 810 reaches a set value T2 and follows the second line 222 after the output value 810 reaches the set value T2.

Meanwhile, a time from a point of time t1 when the control learning model 320 starts to operate to a point of time t3 when the output value 810 reaches the set value T2 is referred to as a first time Δt5.

The artificial intelligence unit 120 may perform reinforcement learning such that the output value 810 follows the first line 221 for the first time Δt5 until the output value 810 reaches the set value T2 and the output value follows the second line 222 for a second time Δt6 after the output value 810 reaches the set value T2.

That is, the artificial intelligence unit 120 may perform reinforcement learning by giving a reward to the gap between the output value 810 and the base line 220 for the first time Δt5 and the second time Δt6.

In this case, the first time Δt5 and the second time Δt6 may be proportional by the following equation 3. Here, α may be a proportional constant.

Second time=α*first time [Equation 3]

For example, if the proportional constant is 1 and the first time from the point of time when the control learning model 320 starts to operate to the point of time when the output value reaches the set value is 2 minutes, the artificial intelligence unit 120 may perform reinforcement learning such that the output value follows the first line 221 for 2 minutes until the output value reaches the set value and the output value follows the second line 222 for 2 minutes after the output value reaches the set value.

As another example, if the proportional constant is 0.8 and the first time from the point of time when the control learning model 320 starts to operate to the point of time when the output value reaches the set value is approximately 2 minutes, the artificial intelligence unit 120 may perform reinforcement learning such that the output value follows the first line 221 for approximately 2 minutes until the output value reaches the set value and the output value follows the second line 222 for approximately 1 minute 36 seconds after the output value reaches the set value.

Fluctuation of the output value above or below the set value is a response to input of energy. As the amount of input energy is increased, a time when the output value fluctuates is increased.

For example, in the heating system, when the output value is from approximately 25° C. to a set value of approximately 30° C., the first time Δt5 is increased and the amount of water for heating, which passes through the pipe by opening the valve, is increased as compared to the case where the output value is from approximately 25° C. to a set value of approximately 26° C. Therefore, when the output value is from approximately 25° C. to a set value of approximately 30° C., fluctuation of the temperature after the temperature reaches to the set value is continued for a longer time.

In the present invention, the first time Δt5 and the second time Δt6 are proportional. Accordingly, the present invention is advantageous in that reinforcement learning is performed after monitoring the output value for a longer time as the amount of input energy is increased, thereby calculating an optimal parameter.

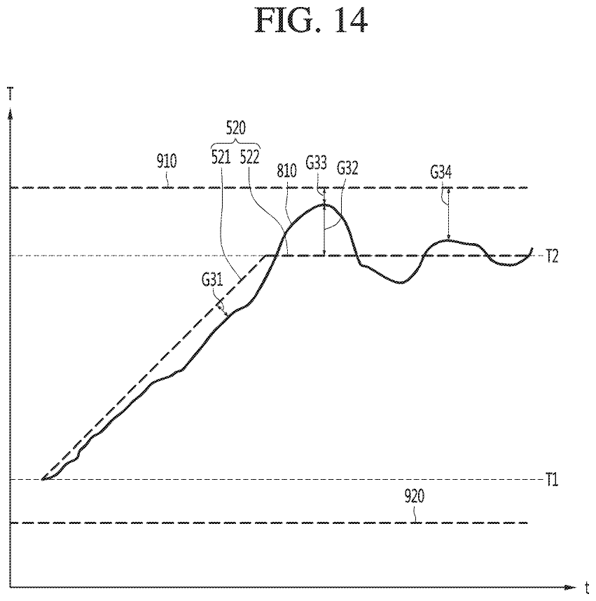

FIG. 14 is a diagram illustrating a method of setting an additional base line and performing reinforcement learning in order to avoid the additional base line according to an embodiment of the present invention.

As described above, the base line 220 is ideal change of the output value according to control of the control learning model 320.

In contrast, the second base line 910 may mean an avoidance goal of avoiding the output value according to control of the control learning model 320.

For example, in the heating system, the second base line 910 may mean a specific temperature.

For example, in order to prevent the temperature to being increased to a specific temperature or more to prevent the user from feeling discomfort or to prevent the temperature to being increased to a specific temperature or more to prevent excessive power consumption, the second base line 910 may be set to a specific temperature. For example, the set value may be 30° C. and the specific temperature may be 40° C.

In addition, the artificial intelligence unit 120 may perform reinforcement learning such that the output value follows the base line and avoids the second base line 910, thereby updating the control function for providing the control value to the control learning model 320. Here, avoiding the second base line may mean moving the output value according to control of the control learning model 320 to be maximally away from the second base line 910.

Specifically, the artificial intelligence unit 120 may give a reward based on the gaps G31 and G32 between the base line 220 and the output value 810 and give a penalty based on the gaps G33 and G34 between the second base line 910 and the output value 810.

More specifically, as the gaps G31 and G32 between the base line 220 and the output value are decreased, the reward may be increased and, as the gaps G33 and G34 between the second base line 910 and the output value 810 are decreased, the penalty may be increased.

The artificial intelligence unit 120 may acquire one or more parameters for maximizing the sum of the reward and the penalty and change the parameter of the existing control function to a newly acquired parameter when the one or more parameters for maximizing the sum of the reward and the penalty are acquired, thereby updating the existing control function.

In this manner, the artificial intelligence unit 120 may continuously perform reinforcement learning, thereby acquiring an optimal parameter for enabling the output value according to control of the control learning model 320 to follow the base line and to avoid the second base line.

In the present invention, the artificial intelligence agent may perform reinforcement learning based on various goals, by setting a plurality of base lines 220 and 910.

Specifically, if it is assumed that there is only a base line 220, an optimal parameter for enabling the output value to most closely follow the base line 220 is determined by an average of the gaps between the base line 220 and the output value 810 (that is, the area of a space between the output value and the base line). Accordingly, even when the average of the gaps is minimized, large overshoot may occur and thus the output value may approach a specific temperature causing an uncomfortable feeling to the user according to overshoot.

Accordingly, the present invention is advantageous in that the plurality of base lines 220 and 910 is set and the artificial intelligence agent learns the optimal parameter for enabling the output value to follow or avoid the base line, thereby calculating the optimal parameter capable of achieving various goals.

Meanwhile, although the two base lines 220 and 910 are set in the above description, the number of base lines is not limited thereto.

For example, in the air conditioning system, the base line 220, the second base line 910 and a third base line 630 may be set. The base line 220 may mean a temperature which the output value (the output temperature) follows, the second base line 910 is a high temperature (e.g., approximately 40° C.) which the output value (the output temperature) avoids, and the third base line 920 may mean a low temperature (e.g., approximately 15° C.) which the output value (the output temperature) avoids. Therefore, the artificial intelligence unit 120 may calculate an optimal parameter for enabling the temperature according to control of the air conditioning system to follow the base line in a range of approximately 15° C. to approximately 40° C.

Meanwhile, as the gaps G31 and G32 between the base line 220 and the output value 810 are decreased, the reward is increased and, as the gaps G33 and G34 between the second base line 910 and the output value 810 are decreased, the penalty is increased. In this case, the magnitude of the penalty may be greater than that of the reward.

For example, when the gap between the base line 220 and the output value 810 is 10 and the gap between the second base line 910 and the output value 810 is 10, the reward of 5 may be given to the gap between the base line 220 and the output value 810 and the penalty of 10 may be given to the gap between the base line 910 and the output value 810.

The specific temperature indicated by the second base line may be a threshold which the output value should not exceed. Accordingly, in the present invention, by differentiating the magnitudes of the reward and the penalty, a higher weight is given to a goal of avoiding the specific temperature indicated by the second base line 910 than a goal of following the base line 220.

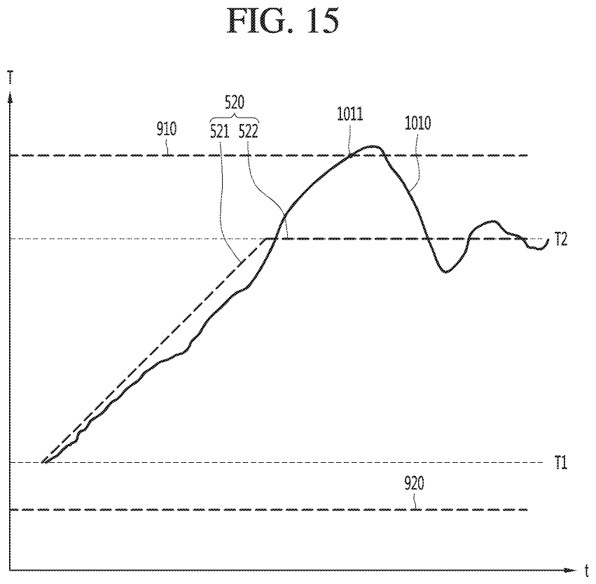

FIG. 15 is a diagram illustrating a method of discarding a parameter when an output value matches one point on a second base line according to an embodiment of the present invention.

Even when reinforcement learning is performed such that the output value follows the base line 220 and avoids the second base line, there is still a possibility that the output value approaches the second base line 910, and the output value may reach the second base line 910.

Meanwhile, the value indicated by the second base line may be a threshold which the output value should not exceed.

Accordingly, the artificial intelligence unit 120 may discard the parameter of the control function for providing the control value to the control learning model 320, when the output value matches one point 1011 on the second base line 910. In addition, the artificial intelligence unit 120 may not use the discarded parameter as the parameter of the control function.

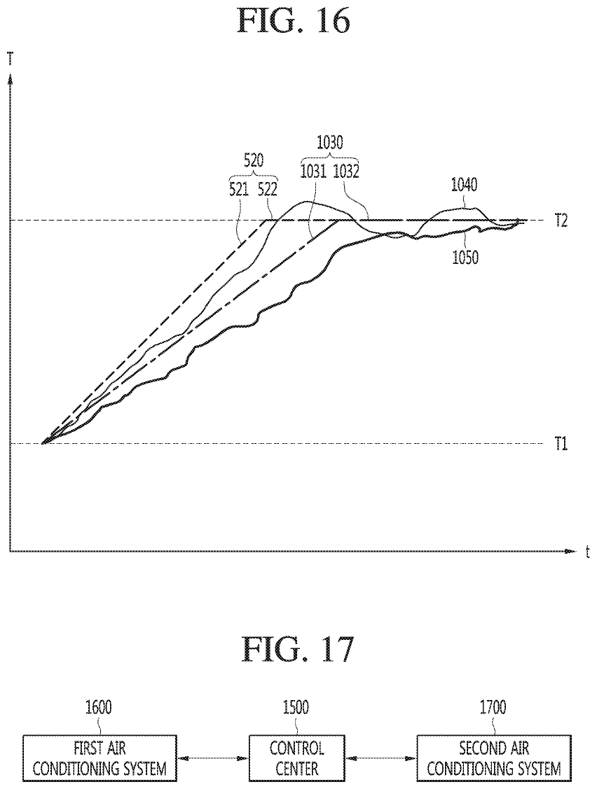

FIG. 16 is a diagram illustrating a method of resetting a base line according to change in environmental condition according to an embodiment of the present invention.

The artificial intelligence unit 120 may reset the base line according to change in environmental condition.

The environmental condition may be an external factor for changing the object to be controlled by the control learning model 320. In other words, the object to be controlled by the control learning model 320 may be changed by a factor other than control of the control learning model 320, and the factor may be referred to as the environmental condition.

For example, if the control learning model 320 is a heating system, the object to be controlled by the heating system is a temperature. The temperature may be changed not only by control of the heating system but also by time, date, season, weather, etc. In this case, the environmental condition may be time, date, season, weather, etc.

As described above, the first line 221 of the base line 220 indicates ideal change of the output value according to control of the control learning model 320 and means change in output value according to maximum control of the control learning model 320.

Meanwhile, ideal change of the output value according to control of the control learning model 320 may be changed according to change in environmental condition.

For example, even when the valve of the heating system is opened by the same degree, the rate of change of the output value (temperature) of summer and the rate of change of the output value (temperature) of winter may be different from each other.

Accordingly, the optimal parameter calculated in summer by performing reinforcement learning after setting change in output value according to maximum control of the control learning model 320 to the base line 221 may be different from the optimal parameter applied in winter.

Accordingly, the artificial intelligence unit 120 according to the embodiment of the present invention may reset the base line 220 according to change in environmental condition.

Specifically, the collection unit 110 may directly acquire the output value or receive the output value from the outside.

In addition, the artificial intelligence unit 120 may sense change in output value. In this case, change in output value may mean change in output value irrespective of control of the control learning model 320, instead of change in output value according to control of the control learning model 320.

When change in output value is sensed, the artificial intelligence unit 120 may control the control learning model 320 to perform maximum control.

In addition, while the control learning model 320 performs maximum control, the artificial intelligence unit 120 may acquire the output value according to maximum control of the control learning model 320. In addition, the artificial intelligence unit 120 may set a first line 1031 of a new base line 1030 based on the acquired output value.

When the first line 1031 of the new base line 1030 is set, the artificial intelligence unit 120 may perform reinforcement learning such that the output value according to control of the control learning model 320 follows the new base line 1030.

The first output value 1040 shown in FIG. 16 indicates an output value obtained by performing reinforcement learning in order to follow the existing base line 220 to acquire an optimal control function and to perform control using a control value provided by the acquired control function.

The second output value 1050 shown in FIG. 16 indicates an output value obtained by performing reinforcement learning in order to follow the new base line 1030 to acquire an optimal control function and to perform control using a control value provided by the acquired control function.

As the environmental condition is changed by season, date or the other variables, an optimal PID parameter suitable for the current environmental condition may be changed. However, conventionally, since the parameter is set through human intuition and experience, it is impossible to appropriately optimize the parameter in correspondence with change in environmental condition.

However, the present invention is advantageous in that the base line is changed when the environmental condition is changed and reinforcement learning is performed again in order to follow the changed base line, thereby optimizing the parameter in correspondence with change in environmental condition.

FIG. 17 is a block diagram illustrating an embodiment in which artificial intelligence devices respectively corresponding to a plurality of control systems are integrally configured in a control center according to an embodiment of the present invention.

For example, the control center 1500 may be a device for integrally managing heating systems of a specific building. A first air conditioning system 1600 may be a control device for controlling heating of a first space of the specific building and a second air conditioning system 1700 may be a control device for controlling heating a second space of the specific building.

The first air conditioning system 1600 may include a controller, an operation unit, a communication unit and a sensing unit. The description of the controller, the operation unit, the communication unit and the sensing unit shown in FIG. 13 is applicable without change, except that the communication unit communicates with the control center 1500.

In addition, the second air conditioning system 1700 may include a controller, an operation unit, a communication unit and a sensing unit. The description of the controller, the operation unit, the communication unit and the sensing unit shown in FIG. 13 is applicable without change, except that the communication unit communicates with the control center 1500.

The control center 1500 may include a collection unit and an artificial intelligence unit.

The artificial intelligence unit may include an energy balance learning model 310 and a control earning model 320.

The description about the collection unit and the artificial intelligence unit in FIG. 12 will be applied as it is to the collection unit and the artificial intelligence unit of the control center 1500.

Meanwhile, the artificial intelligence unit of the control center 1500 may receive an output value according to control of the first air conditioning system 1600 from the first air conditioning system 1600 and update a first control function for providing a control value to the first air conditioning system 1600 based on reinforcement learning.

In addition, the artificial intelligence unit of the control center 1500 may receive an output value according to control of the second air conditioning system 1700 from the second air conditioning system 1700 and update a second control function for providing a control value to the second air conditioning system 1700 based on reinforcement learning.

In addition, the artificial intelligence unit of the control center 1500 may reset the base line of the first air conditioning system 1600 using an environmental condition acquired by the second air conditioning system 1700.

For example, when change in environmental condition is sensed according to the result of sensing by the sensing unit of the second air conditioning system 1700, the artificial intelligence unit of the control center 1500 may reset the base line of the first air conditioning system 1600.

That is, the sensed information acquired by the second air conditioning system may be used to update the control function of the first air conditioning system.

Although the PID is used as a control function in the above description, the present invention is not limited thereto.

For example, the control function may include one of proportional-integral (PI) control, proportional-derivative (PD) control and proportional-integral-derivative (PID) control.

In addition, the control function may include all types of functions for providing the control value to the air conditioning system in order to perform feedback control.

Effects of an air conditioning system and a method for controlling the same will be described as the following.

According to at least one of the embodiments, an optimal predicted temperature value may be acquired by the update of a very small number of hyper parameters of an energy balance learning model, and therefore there is a merit that computing power and learning time may remarkably be reduced.

According to at least one of the embodiments, a very small number of hyper parameters are used for an energy balance learning model, and thus, even when using relatively small amount of temperature related data, for example, temperature related data collected for one hour, 10 hours, or one day, a predicted temperature value having sufficiently high accuracy may be acquired. Thus, computing power and the learning time may remarkably be reduced. Since the computing may be reduced, there is a merit of being capable of implementation in a small-sized computer such as raspberry pi.

According to at least one of the embodiments, an air conditioning device operates and is maintained at a constant temperature according to the control value acquired more accurately and quickly based on the predicted temperature value acquired by the energy balance learning model, so that there is a merit of providing a user with a comfortable environment and being capable of efficient energy consumption.

The applicability and an additional range of the embodiments will be obvious from the following detailed description. However, various changes and modifications within the spirit and scope of the embodiments will be clearly understood to those skilled in the art, and thus, the detailed description and specific embodiments such as a preferable embodiment should be understood as being provided as merely an example.

The abovementioned detailed description should not be interpreted to be limitative in all aspects but considered as being exemplary. The scope of the embodiments should be defined by appropriate interpretation of the appended claims, and all modifications within equivalent scopes of the embodiments are construed as being included the scope of the embodiments.

What is claimed is:

1. A method for controlling an air conditioning system comprising:
learning a first learning model so as to acquire a first predicted temperature value according to a first hyper parameter updated based on first temperature related data;
learning a second learning model so as to acquire a first control value based on the acquired first estimate temperature value; and
controlling an air conditioning device so as to operate the air conditioning device according to the acquired first control value.

2. The method for controlling an air conditioning system of claim 1, wherein the first temperature related data is collected by operating the air conditioning device for a predetermined time period before learning of the first learning model.

3. The method for controlling an air conditioning system of claim 2, wherein the predetermined time period is one of approximately one hour, approximately 10 hours, or approximately one day.

4. The method for controlling an air conditioning system of claim 1, wherein the first temperature related data is previously provided training data.

5. The method for controlling an air conditioning system of claim 1, wherein the first hyper parameter comprises at least two among a flow rate, the specific heat of the air, the area of a conductive wall surface, or the temperature of the external air.

6. The method for controlling an air conditioning system of claim 1, further comprising:
acquiring second temperature related data by operating the air conditioning device;
learning the first learning model so as to acquire a second predicted temperature value according to a second hyper parameter updated based on the second temperature related data;
learning the second learning model so as to acquire a second control value based on the acquired second predicted temperature value; and
controlling the air conditioning device so as to operate the air conditioning device according to the acquired second control value.

7. The method for controlling an air conditioning system claim 6, wherein the earning of the second learning model comprises:
updating a control parameter based on the first predicted temperature value or the second predicted temperature value; and
learning the second learning model based on the updated control parameter to acquire an optimal control value.

8. The method for controlling an air conditioning system of claim 6, wherein the learning of the first learning model comprises:
repeatedly updating the second hyper parameter so as to minimize a difference between the actual temperature value and the second predicted temperature value; and
learning the first learning model based on the updated second hyper parameter to acquire an optimal predicted temperature value.

9. An air conditioning system comprising:
an air conditioning device;
a memory configured to store a first learning model and a second learning model; and
a processor,
wherein the processor is configured:
to learn first learning model so as to acquire a first predicted temperature value according to a first hyper parameter updated based on first temperature related data,
to learn the second learning model so as to acquire a first control value based on the acquired first predicted temperature value, and
control the air conditioner so as to operate the air conditioning device according to the acquired first control value.

10. The air conditioning system of claim 9, further comprising a collection unit, wherein
the processor operates the air conditioning device for a predetermined time period, and
the collection unit collects the first temperature related data for a predetermined time period after the operation of the air conditioning device.

11. The air conditioning system of claim 10, wherein the predetermined time period is one of approximately one hour, approximately 10 hours, or approximately one day.

12. The air conditioning system of claim 9, wherein the first temperature related data is previously provided training data.

13. The air conditioning system of claim 9, wherein the first hyper parameter comprises at least two among a flow rate, the specific heat of the air, the area of a conductive wall surface, or the temperature of the external air.

14. The air conditioning system of claim 9, wherein the processor
acquires second temperature related data by operating the air conditioning device,
learns the first learning model so as to acquire a second predicted temperature value according to a second hyper parameter updated based on the second temperature related data,
learns the second learning model so as to acquire a second control value based on the acquired second predicted temperature value, and
controls the air conditioning device so as to operate the air conditioning device according to the acquired second control value.

15. The air conditioning system of claim 14, wherein the processor
updates control parameter based on the first predicted temperature value or the second predicted temperature value, and
acquires an optimal control value by learning the second learning model based on the updated control parameter.

16. The air conditioning system of claim 14, wherein the processor
repeatedly updates the second hyper parameter so as to minimize a difference between the actual temperature value and the second predicted temperature value, and
learns the first learning model based on the updated second hyper parameter to acquire an optimal predicted temperature value.
